(19) United States
(12) Patent Application Publication
(10) Pub. No.: US 2026/0239492 A1
(43) Pub. Date: Aug. 13, 2026

(54) TIME ALIGNMENT ERROR GROUPING FOR MULTIPLE TRANSMISSION-RECEPTION POINTS

(71) Applicant: Nokia Technologies Oy, Espoo (FI)

(72) Inventors: Ali KARIMIDEHKORDI, Munich (DE); Paolo BARACCA, Munich (DE); Diomidis MICHALOPOULOS, Munich (DE); Morten TOFT, Aalborg (DK); Samantha CAPORAL DEL BARRIO, Aalborg (DK)

(21) Appl. No.: 19/154,271

(22) PCT Filed: Feb. 16, 2023
(86) PCT No.: PCT/EP2023/053881

§ 371 Date: Aug. 6, 2025

(51) Int. Cl. H04W 76/38; H04L 5/00

(52) U.S. Cl. CPC H04W 76/38; H04L 5/0044

(57) ABSTRACT

Disclosed is a method comprising determining receiving, from a network entity, a configuration indicating a group comprising transmission and receptions points having a realized timing alignment error upper-bounded by a threshold value, having a first connection to a first transmission and reception point comprised in the group, obtaining a first timing advance value for uplink transmission to the first transmission and reception point, determining that a second connection is to be established to a second transmission and reception point, determining whether the second transmission and reception point is comprised in the group based on the received configuration, responsive to the second transmission and reception point being comprised in the group, measuring a received time difference between the first transmission and reception point and the second transmission and reception point, and determining a second timing advance value for uplink transmission to the second transmission and reception point based on the obtained first timing advance value and the measured received time difference.

### FIELD

The following exemplary embodiments relate to wireless communication and time alignment errors with respect to multiple transmission-reception points in a wireless communication network.

### BACKGROUND

Cellular communication networks may comprise multiple transmission-reception points. A transmission of simultaneous signals from two or more different transmission-reception points (TRPs) may be subjected to timing alignment error (TAE) between the two or more TRPs.

### BRIEF DESCRIPTION

The scope of protection sought for various embodiments of the invention is set out by the independent claims. The exemplary embodiments and features, if any, described in this specification that do not fall under the scope of the independent claims are to be interpreted as examples useful for understanding various embodiments of the invention.

According to a first aspect there is provided an apparatus comprising: means for receiving, from a network entity, a configuration indicating a group of transmission and receptions points having a realized timing alignment error upper-bounded by a threshold value, means for establishing a first connection to a first transmission and reception point comprised in the group, means for receiving a first timing advance value for uplink transmission to the first transmission and reception point, means for determining that a second connection is to be established to a second transmission and reception point, means for determining whether the second transmission and reception point is comprised in the group based on the received configuration, means for, responsive to the second transmission and reception point being comprised in the group, measuring a received time difference between the first transmission and reception point and the second transmission and reception point, and determining a second timing advance value for uplink transmission to the second transmission and reception point based on the obtained first timing advance value and the measured received time difference.

In some example embodiments according to the first aspect, the means comprises at least one processor, and at least one memory storing instructions that, when executed by the at least one processor, to cause the performance of the apparatus.

According to a second aspect there is provided an apparatus comprising at least one processor, and at least one memory storing instructions that, when executed by the at least one processor, to cause the apparatus at least to: receive, from a network entity, a configuration indicating a group of transmission and receptions points having a realized timing alignment error upper-bounded by a threshold value, establish a first connection to a first transmission and reception point comprised in the group, receive a first timing advance value for uplink transmission to the first transmission and reception point, determine that a second connection is to be established to a second transmission and reception point, determine whether the second transmission and reception point is comprised in the group based on the received configuration, responsive to the second transmission and reception point being comprised in the group, measure a received time difference between the first transmission and reception point and the second transmission and reception point, and determine a second timing advance value for uplink transmission to the second transmission and reception point based on the received first timing advance value and the measured received time difference.

According to a third aspect there is provided a method comprising: receiving, from a network entity, a configuration indicating a group of transmission and receptions points having a realized timing alignment error upper-bounded by a threshold value, establishing a first connection to a first transmission and reception point comprised in the group, receiving a first timing advance value for uplink transmission to the first transmission and reception point, determining that a second connection is to be established to a second transmission and reception point, determining whether the second transmission and reception point is comprised in the group based on the received configuration, responsive to the second transmission and reception point being comprised in the group, measuring a received time difference between the first transmission and reception point and the second transmission and reception point, and determining a second timing advance value for uplink transmission to the second transmission and reception point based on the received first timing advance value and the measured received time difference.

In some example embodiment according to the third aspect the method is a computer implemented method.

According to a fourth aspect there is provided a computer program comprising instructions which, when executed by an apparatus, cause the apparatus to perform at least the following: receiving, from a network entity, a configuration indicating a group of transmission and receptions points having a realized timing alignment error upper-bounded by a threshold value, establishing a first connection to a first transmission and reception point comprised in the group, receiving a first timing advance value for uplink transmission to the first transmission and reception point, determining that a second connection is to be established to a second transmission and reception point, determining whether the second transmission and reception point is comprised in the group based on the received configuration, responsive to the second transmission and reception point being comprised in the group, measuring a received time difference between the first transmission and reception point and the second transmission and reception point, and determining a second timing advance value for uplink transmission to the second transmission and reception point based on the received first timing advance value and the measured received time difference.

According to a fifth aspect there is provided a computer program comprising instructions stored thereon for performing at least the following: receiving, from a network entity, a configuration indicating a group of transmission and receptions points having a realized timing alignment error upper-bounded by a threshold value, establishing a first connection to a first transmission and reception point comprised in the group, receiving a first timing advance value for uplink transmission to the first transmission and reception point, determining that a second connection is to be established to a second transmission and reception point, determining whether the second transmission and reception point is comprised in the group based on the received configuration, responsive to the second transmission and reception point being comprised in the group, measuring a received time difference between the first transmission and reception point and the second transmission and reception point, and determining a second timing advance value for uplink transmission to the second transmission and reception point based on the received first timing advance value and the measured received time difference.

According to a sixth aspect there is provided a non-transitory computer readable medium comprising program instructions that, when executed by an apparatus, cause the apparatus to perform at least the following: receiving, from a network entity, a configuration indicating a group of transmission and receptions points having a realized timing alignment error upper-bounded by a threshold value, establishing a first connection to a first transmission and reception point comprised in the group, receiving a first timing advance value for uplink transmission to the first transmission and reception point, determining that a second connection is to be established to a second transmission and reception point, determining whether the second transmission and reception point is comprised in the group based on the received configuration, responsive to the second transmission and reception point being comprised in the group, measuring a received time difference between the first transmission and reception point and the second transmission and reception point, and determining a second timing advance value for uplink transmission to the second transmission and reception point based on the received first timing advance value and the measured received time difference.

According to a seventh aspect there is provided a non-transitory computer readable medium comprising program instructions stored thereon for performing at least the following: receiving, from a network entity, a configuration indicating a group of transmission and receptions points having a realized timing alignment error upper-bounded by a threshold value, establishing a first connection to a first transmission and reception point comprised in the group, receiving a first timing advance value for uplink transmission to the first transmission and reception point, determining that a second connection is to be established to a second transmission and reception point, determining whether the second transmission and reception point is comprised in the group based on the received configuration, responsive to the second transmission and reception point being comprised in the group, measuring a received time difference between the first transmission and reception point and the second transmission and reception point, and determining a second timing advance value for uplink transmission to the second transmission and reception point based on the received first timing advance value and the measured received time difference.

According to an eighth aspect there is provided a computer readable medium comprising program instructions that, when executed by an apparatus, cause the apparatus to perform at least the following: receiving, from a network entity, a configuration indicating a group of transmission and receptions points having a realized timing alignment error upper-bounded by a threshold value, establishing a first connection to a first transmission and reception point comprised in the group, receiving a first timing advance value for uplink transmission to the first transmission and reception point, determining that a second connection is to be established to a second transmission and reception point, determining whether the second transmission and reception point is comprised in the group based on the received configuration, responsive to the second transmission and reception point being comprised in the group, measuring a received time difference between the first transmission and reception point and the second transmission and reception point, and determining a second timing advance value for uplink transmission to the second transmission and reception point based on the received first timing advance value and the measured received time difference.

According to a ninth aspect there is provided a computer readable medium comprising program instructions stored thereon for performing at least the following: receiving, from a network entity, a configuration indicating a group of transmission and receptions points having a realized timing alignment error upper-bounded by a threshold value, establishing a first connection to a first transmission and reception point comprised in the group, receiving a first timing advance value for uplink transmission to the first transmission and reception point, determining that a second connection is to be established to a second transmission and reception point, determining whether the second transmission and reception point is comprised in the group based on the received configuration, responsive to the second transmission and reception point being comprised in the group, measuring a received time difference between the first transmission and reception point and the second transmission and reception point, and determining a second timing advance value for uplink transmission to the second transmission and reception point based on the received first timing advance value and the measured received time difference.

According to a tenth aspect there is provided an apparatus comprising: means for determining a group of transmission and receptions points having a realized timing alignment error upper-bounded by a threshold value, and means for transmitting, to a terminal device, a configuration indicating the group.

In some example embodiments according to the tenth aspect, the means comprises at least one processor, and at least one memory storing instructions that, when executed by the at least one processor, to cause the performance of the apparatus.

According to an eleventh aspect there is provided an apparatus comprising at least one processor, and at least one memory storing instructions that, when executed by the at least one processor, to cause the apparatus at least to: determine a group of transmission and receptions points having a realized timing alignment error upper-bounded by a threshold value, and transmit, to a terminal device, a configuration indicating the group.

According to a twelfth aspect there is provided a method comprising: determining a group of transmission and receptions points having a realized timing alignment error upper-bounded by a threshold value, and transmitting, to a terminal device, a configuration indicating the group.

In some example embodiment according to the twelfth aspect the method is a computer implemented method.

According to a thirteenth aspect there is provided a computer program comprising instructions which, when executed by an apparatus, cause the apparatus to perform at least the following: determining a group of transmission and receptions points having a realized timing alignment error upper-bounded by a threshold value, and transmitting, to a terminal device, a configuration indicating the group.

According to a fourteenth aspect there is provided a computer program comprising instructions stored thereon for performing at least the following: determining a group of transmission and receptions points having a realized timing alignment error upper-bounded by a threshold value, and transmitting, to a terminal device, a configuration indicating the group.

According to a fifteenth aspect there is provided a non-transitory computer readable medium comprising program instructions that, when executed by an apparatus, cause the apparatus to perform at least the following: determining a group of transmission and receptions points having a realized timing alignment error upper-bounded by a threshold value, and transmitting, to a terminal device, a configuration indicating the group.

According to a sixteenth aspect there is provided a non-transitory computer readable medium comprising program instructions stored thereon for performing at least the following: determining a group of transmission and receptions points having a realized timing alignment error upper-bounded by a threshold value, and transmitting, to a terminal device, a configuration indicating the group.

According to a seventeenth aspect there is provided a computer readable medium comprising program instructions that, when executed by an apparatus, cause the apparatus to perform at least the following: determining a group of transmission and receptions points having a realized timing alignment error upper-bounded by a threshold value, and transmit, to a terminal device, a configuration indicating the group.

According to a eighteenth aspect there is provided a computer readable medium comprising program instructions stored thereon for performing at least the following: determining a group of transmission and receptions points having a realized timing alignment error upper-bounded by a threshold value, and transmitting, to a terminal device, a configuration indicating the group.

### LIST OF DRAWINGS

In the following, the invention will be described in greater detail with reference to the embodiments and the accompanying drawings, in which:

FIG. 1 illustrates an example embodiment of a radio access network;

FIG. 2 illustrates an example embodiment of network topologies;

FIG. 3 illustrates an example embodiment of timing for a terminal device transmitting and receiving signals using multiple transmission and reception points;

FIG. 4 illustrates an example embodiment in which there are realized time alignment errors that are unknown to a terminal device;

FIG. 5A and FIG. 5B illustrate example embodiments in which the terminal device connects to multiple transmission and reception points;

FIG. 6 illustrates a signaling chart according to an example embodiment;

FIG. 7 illustrates a flow chart according to an example embodiment;

FIG. 8 illustrates time alignment errors in different example scenarios; and

FIG. 9 and FIG. 10 illustrate example embodiments of an apparatus.

### DESCRIPTION OF EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. The above-described embodiments of the circuitry may also be considered as embodiments that provide means for carrying out the embodiments of the methods or processes described in this document.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via any suitable means. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments described herein may be implemented in a communication system, such as in at least one of the following: Global System for Mobile Communications (GSM) or any other second generation cellular communication system, Universal Mobile Telecommunication System (UMTS, 3G) based on basic wideband-code division multiple access (W-CDMA), high-speed packet access (HSPA), Long Term Evolution (LTE), LTE-Advanced, a system based on IEEE 802.11 specifications, a system based on IEEE 802.15 specifications, and/or a fifth generation (5G), as well as 5G-Advanced (i.e. 3GPP NR Rel-18 and beyond), mobile or cellular communication system. Also, the embodiments described herein may be implemented in a 6G communication system as well. The embodiments are not, however, restricted to the system given as an example but a person skilled in the art may apply the solution to other communication systems provided with necessary properties.

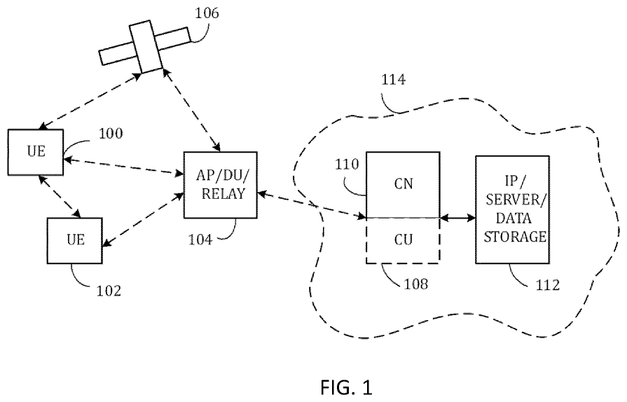

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may comprise also other functions and structures than those shown in FIG. 1. The example of FIG. 1 shows a part of an exemplifying radio access network.

FIG. 1 shows terminal devices 100 and 102 configured to be in a wireless connection on one or more communication channels in a cell with an access node (such as (e/g)NodeB) 104 providing the cell. The access node 104 may also be referred to as a node, network node, network device, gNB, gNodeB, NB, Node B, or base station. The wireless link from a terminal device to a (e/g)NodeB is called uplink or reverse link and the wireless link from the (e/g)NodeB to the terminal device is called downlink or forward link. It should be appreciated that (e/g)NodeBs or their functionalities may be implemented by using any node, host, server or access point etc. entity suitable for such a usage. It is to be noted that although one cell is discussed in this exemplary embodiment, for the sake of simplicity of explanation, multiple cells may be provided by one access node in some exemplary embodiments.

A communication system may comprise more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The (e/g)NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the deployed technology, the counterpart on the CN side may be a serving gateway (S-GW, routing and forwarding user data packets) or a user plane function (UPF) for providing connectivity of terminal devices (UEs) to external packet data networks, and a mobile management entity (MME) or an access and mobility function (AMF) for controlling access and mobility of terminal devices.

The terminal device illustrates one type of an apparatus to which resources on the air interface are allocated and assigned, and thus any feature described herein with a terminal device may be implemented with a corresponding apparatus, such as a relay node. An example of such a relay node is a layer 3 relay (self-backhauling relay) towards the base station. Another example of such a relay node is a layer 2 relay. Such a relay node may contain a terminal device part and a Distributed Unit (DU) part. A CU (centralized unit) may coordinate the DU operation via F1AP-interface for example.

The terminal device may also be referred to as a user equipment (UE), a subscriber device, a subscriber station (SS), a portable subscriber station, a mobile station (MS), or an access terminal (AT). The terminal device may refer to a portable computing device that includes wireless mobile communication devices operating with or without a subscriber identification module (SIM), or an embedded SIM, eSIM, including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be an exclusive or a nearly exclusive uplink only device, of which an example is a camera or video camera loading images or video clips to a network. A terminal device may also be a device having capability to operate in Internet of Things (IoT) network which is a scenario in which objects are provided with the ability to transfer data over a network without requiring human-to-human or human-to-computer interaction. The terminal device may also utilise cloud. In some applications, a terminal device may comprise a small portable device with radio parts (such as a watch, earphones or eyeglasses) and the computation is carried out in the cloud. The terminal device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications such as (massive) machine-type communications (mMTC), including vehicular safety, different sensors and real-time control. 5G is expected to have multiple radio interfaces, namely below 6 GHz, cmWave and mmWave, and also being integratable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G may require bringing the content close to the radio which may lead to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, and/or utilise services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of functions between core network operations and base station operations may differ from that of the LTE or even be non-existent. Some other technology that may be used includes for example Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling or service availability in areas that do not have terrestrial coverage. Satellite communication may utilise geostationary earth orbit (GEO) satellite systems, but also low earth orbit (LEO) satellite systems, for example, mega-constellations. A satellite 106 comprised in a constellation may carry a gNB, or at least part of the gNB, that create on-ground cells. Alternatively, a satellite 106 may be used to relay signals of one or more cells to the Earth. The on-ground cells may be created through an on-ground relay node 104 or by a gNB located on-ground or in a satellite or part of the gNB may be on a satellite, the DU for example, and part of the gNB may be on the ground, the CU for example. Additionally, or alternatively, high-altitude platform station, HAPS, systems may be utilized.

It is to be noted that the depicted system is an example of a part of a radio access system and the system may comprise a plurality of (e/g)NodeBs, the terminal device may have an access to a plurality of radio cells and the system may comprise also other apparatuses, such as physical layer relay nodes or other network elements, etc. At least one of the (e/g)NodeBs may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. In some exemplary embodiments, in multilayer networks, one access node provides one kind of a cell or cells, and thus a plurality of (e/g)NodeBs are required to provide such a network structure.

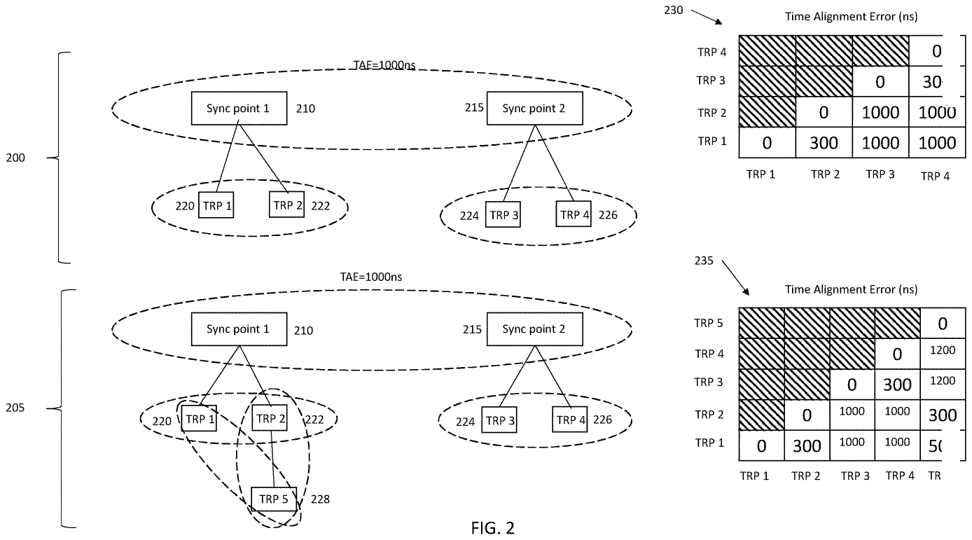

When a network comprises more than one TRPs, a timing alignment error (TAE) may occur between any pair of two TRPs. The TAE may be understood as a relative difference in the transmission timing between a pair of two TRPs (the transmission timing may be defined with respect to symbol/slot/sub-frame/frame boundaries). A maximum value for the TAE may be determined for the network and for example, a 3GPP specification may be used to determine the pre-determined value for the maximum TAE between any pair of TRPs is to comply with. In other words, the TAE for the pair of TRPs is to be below or equal to the pre-determined maximum value. This maximum value may also be understood as a TAE requirement. The actual TAE, that is the realized TAE, may depend on how far apart from each other the TRPs are. Thus, the realized TAE may be much smaller than the pre-determined maximum value. FIG. 2 illustrates an example embodiment of different network topologies and synchronization of TRPs in those topologies. FIG. 2 illustrates two example scenarios 200 and 205. In this example embodiment, there are two different synchronization points, 210 and 215. A relative time accuracy between the synchronization points 210 and 215 is 1000 ns in this example embodiment. In the scenario 200 and in the scenario 205, the synchronization point 210 is connected to TRP 220 and to TRP 222, and the synchronization point 215 is connected to TRP 224 and to TRP 226. Both of the synchronization points 210 and 215 are connected to their respective TRPs with a relative time accuracy of 300 ns. In the example scenario 205, the TRP 222 is further connected to TRP 228 with a 300 ns timing accuracy. This results in the timing accuracy between the TRP 220 and TRP 228 being higher, for example, up to 500 ns. TAEs between the TRPs 220, 222, 224 and 226 for the scenario 200 are illustrated in table 230. TAEs between the TRPs 220, 222, 224, 226 and 228 for the scenario 205 are illustrated in table 235. While the network topologies in the example scenarios 200 and 205 both fulfil the same TAE requirements, for example, the maximum TAE value being 3000 ns, the realized TAE between any two of the TRPs 220, 222, 224, 226 and 228 is different. The realized TAE may be specific to a deployment, and may also depend on network implementation. Further, a terminal device is not aware of the realized TAE between any two TRPs.

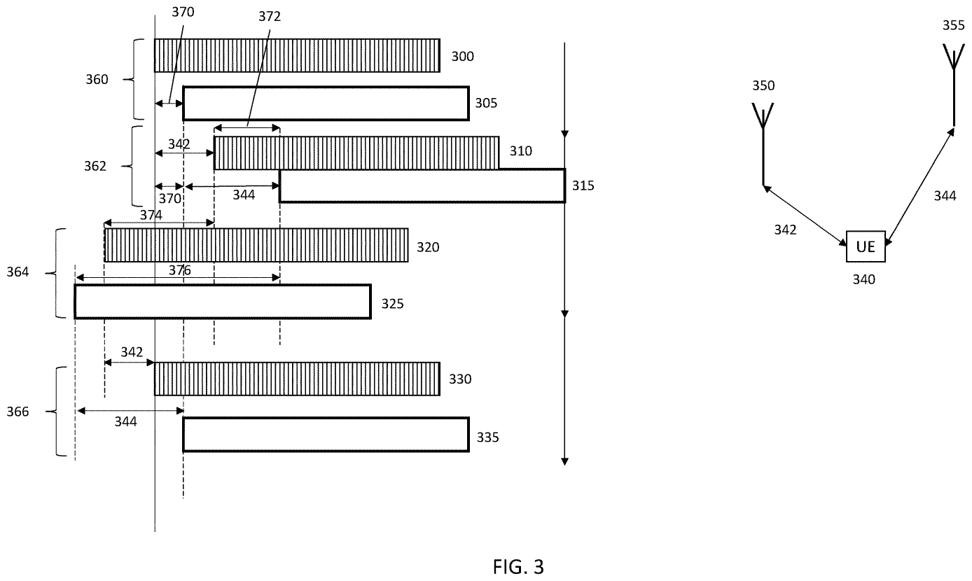

FIG. 3 illustrates an example embodiment of timing for a terminal device 340 that is connected to a TRP 350 and to a TRP 355, and transmits uplink (UL) transmissions to both TRPs 350 and 355, and also receives downlink (DL) transmissions from the TRPs 350 and 355. The propagation delay 342 is the propagation delay applicable between the terminal device 340 and the TRP 350. The propagation delay 344 is the propagation delay applicable between the terminal device 340 and the TRP 355.

In this example embodiment, the timing aspects of both DL and UL transmissions are illustrated. Section 360 illustrates transmissions of DL signals by the TRPs 350 and 355 to the terminal device 340. The DL transmission 305 from TRP 355 is delayed by TAE 370 with respect to the DL transmission 300 from TRP 350.

Section 362 illustrates reception, by the terminal device 340, of DL signals transmitted by the TRPs 350 and 355. The DL transmission 300 is received as DL reception 310 at the terminal device 340 and the DL transmission 305 is received as DL reception 315 at the terminal device 340. The DL reception 310 occurs after the propagation delay 342 with respect to the DL transmission 300. The DL reception 315 occurs after the propagation delay 344 with respect to the DL transmission 305. From the perspective of the terminal device, there is a receive time difference (RTD) 372 between the DL receptions 310 and 315. The RTD 372 may be estimated by the terminal device 340 based on DL reference signals (RS) received from the TRPs 350 and 355, such as such as synchronization signal block (SSB) or channel state information-reference signal (CSI-RS) or phase tracking-reference signal (PT-RS).

Section 364 illustrates UL transmission 320 that the terminal device 340 transmits to the TRP 350, and the UL transmission 325 that the terminal device 340 transmits to the TRP 355. In this example embodiment, it is assumed that that the terminal device 340 has already obtained correct timing advance (TA) values for uplink transmissions to the TRPs 350 and 355. The TA value for the TRP 350 is TA 374, which equals to 2*propagation delay 342, and the TA value for the TRP 355 is TA 376, which equals to 2*propagation delay 344. The timing advance values to be used by the terminal device 340 for the TRPs 350 and 355 are defined with respect to the DL receptions 310 and 315 respectively.

Section 366 illustrates UL reception 330 by the TRP 350 of the UL transmission 320, and UL reception 335 by the TRP 355 of the UL transmission 325. The reception 330 is aligned with the transmission 300 and the reception 335 is aligned with the transmission 305 on account of the correct timing advance values 374 and 376 respectively.

As can be seen from the illustration of FIG. 3, the TA 376 for the TRP 355 is equal to:

$$TA 3 \; 76 = TA 374 + 2 * RTD 372 - 2 * Realized ( TAE 370 )$$

In case of ideal synchronisation between the TRPs 350 and 355, meaning in case the realized TAE=0, the terminal device 340 can estimate correctly TA 376 based on TA 374 and observed RTD 372. However, in actual deployments, it may be that TA 376 cannot be derived from TA 374, neither at an access node, such as a gNB, that comprises at least one of the TRPs, as the access node is not aware of the RTD, nor at the terminal device as the terminal device is not aware of the realized TAE. As such, if the realized TAE≠0 and it is not known by the terminal device, then the terminal device may not be able to precisely derive TA 376 from TA 374 and the resulting UL time alignment error on TRP 355 will then be equal to Realized TAE 370.

It is also to be noted that a timing advance command (TAC) may be used to inform a terminal device regarding the amount of time that the terminal device needs to advance the UL transmissions. The TAC may be in medium access control (MAC) control element (CE), or it may included in a random access response (RAR). The TA may be controlled by MAC layer and implemented in physical layer. TAC may be in accordance with a 3GPP standard.

In some example embodiments, there may be mTRPs, for example N TRPs, and an operation is to be performed that involves the mTRPs. If M<N and M TACs are allowed or enabled, then a procedure is needed such that a terminal device may perform UL transmission toward the N TRPs still even though just M TACs are available.

For example, a terminal device is connected to a first TRP, and there are two TRPs If a second TRP is added after the terminal device is connected to the first TRP, then the terminal device should have a procedure to determine an initial TA value for uplink transmission to the second TRP. It would be desirable if the procedure was not as consuming in terms of resources such as random access control channel (RACH) resources. It is also to be noted that the terminal device may acquire TA values of a set of candidate target cells before cell switch execution to reduce handover interruption time. Yet, this may result in a need to obtain multiple TA values which may impose additional inter-cell signalling overhead and delay to coordinate RACH-based TA acquisition or update.

Thus, in case there are N TRPs, corresponding to N cells, and the network provides a TA value or command for only M<N TRPs, in other words, to M cells, the terminal device is to be able to calculate the TA value for the remaining N-M TRPs as well. The terminal device may be able to calculate a timing difference for the remaining N-M TRPs using downlink reference signal (DL-RS), such as SSB, CSI-RS or PT-RS. Yet, those differences may be unprecise or even incorrect because the terminal device is not aware of the realized TAE among the TRPs. Yet, to obtain precise TA values, for the N−M TRPs, realized inter-TRP TAE is to be known. The realized inter-TRP TAE may be dependent on various aspects such as deployment or TRP hardware implementation. While the terminal device may be aware of the pre-determined maximum value for the TAE among the multiple TRPs, the realized TAE values may not be known to the terminal device.

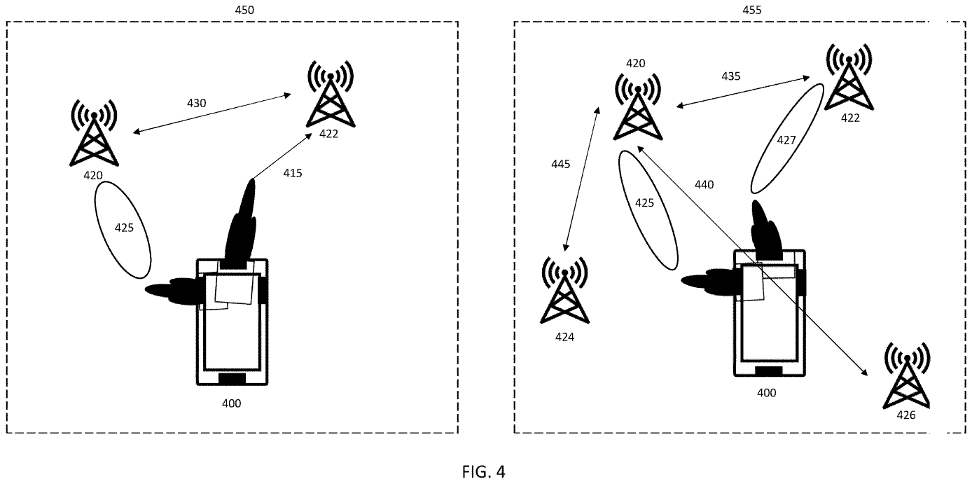

FIG. 4 illustrates an example embodiment in which there are realized TAEs unknown to a terminal device. The network provides, in this example embodiment, a terminal device 400 with a TA value of the TRP 420 using a TA command 425. This is illustrated in the example scenario 450 of the FIG. 4. Thus, the terminal device 400 is not aware of the realized TAE 430 and is to use RACH towards the TRP 422 if it is to be connected to the TRP 422. In the example scenario 455, on the other hand, the network provides the terminal device 400 with the TA command 425 as well as with the TA command 427 that indicates the TA value of the TRP 422. In this example scenario, there are also two additional TRPs, namely TRPs 424 and 426. Although the terminal device 400 is aware of the TAE requirement that sets the maximum value for the TAE to be 1000 ns in this example embodiment, the terminal device is not aware of the realized TAEs 435, 440 and 445. It would however be beneficial for the terminal device 400 to be able to determine the realized TAEs 440 and 445 so that based on those, and based on received timing difference, it could also calculate the TA values for the TRP 424 and TRP 426.

In the context of this document, TRP is understood to refer to, and thus to cover, intra-cell as well as inter-cell scenarios. In an intra-cell scenario, the multiple TRPs belong to the same cell and thus have the same physical cell ID (PCI). In an inter-cell scenario, the multiple TRPs have different PCIs, and thus belong to different cells. It is also to be noted that some of the TRPs may be comprised in a same access node and some may be comprised in different access nodes. As the functionality of an access node may comprised DU part that is in a different location than the CU, the DU may be collocated with one or more TRPs. Thus, the TRPs, DUs and CU may all be understood as part of a network and may be referred to as entities of a network.

In an example embodiment, a terminal device may use a procedure for determining TA values, when the number of TA values is M though there are N TRPs and M<N. Determining may refer to acquiring or to updating TA values. The network may for example group together TRPs with realized TAE values that are considered as small based on criteria such as being below, or equal to a threshold value. In other words, there is an upper limit value, that is the threshold value, and the realized TAE value is upper bounded by that threshold value. Such a group may be understood as a TAE group (TAEG). For example, the network may configure a group of TRPs such that the maximum realized TAE among two TRPs within the same TAEG is below, or equal to, a certain threshold value. The threshold value may be explicitly defined for example in a specification to be for example 500 ns. Alternatively, the threshold may be determined by the network and may be based on TA accuracy requirement. The network may be understood as any suitable entity in the network, for example, an access node that may comprise one or more of the TRPs. In this example embodiment, in case there are more than one TAEGs created, for each TAEG that may be used for serving a terminal device, the TA loop for at least one TRP belonging to the TAEG has already been initialized. The at least one TRP may be referred to as a primary TRP. Criteria for creating a TAEG may depend on TRP deployment as well as on network topology. TAEG may be for example created based on statically, as part of operations, administration and maintenance (OAM) for example. Alternatively, the TAEGs may be created dynamically. It is to be noted that updating an existing TAEG dynamically may also be understood as creating a TAEG dynamically. A benefit of statically creating the TAEG is that it is simple. On the other hand, a benefit of dynamically creating the TAEGs is that it may be helpful in some specific deployments such as mobile terminal devices or moving TRPs on drones. It is also to be noted that within one TAEG the TAE may be small enough such that the terminal device does not need to use RACH to switch or add a transmission configuration indicator (TCI) state.

Next, in this example embodiment, the network may provide signaling indicating the created one or more TAEGs to the terminal device. This may be done using a TAEG message. The message may be transmitted for example by the TRP serving the terminal device. The serving TRP may also be the primary TRP, and it is a TRP to which the terminal device has a connection. The message may comprise information regarding the created TAEGs. As the terminal device is already connected to the primary TRP and thus the TA loop is already initialized for the TRPs in the same TAEG, the TRPs may then each transmit a message comprising the information regarding the other TRPs comprised in the same TAEG. The message may optionally also comprise information regarding a threshold value used when creating the TAEGs.

Then, the terminal device may measure received DL RS, such as SSB or CSI-RS or PT-RS, and, based on the measurement, and for each of the TAEG, estimate the RTD between the primary TRP and other TRPs in the same TAEG, which may be understood as secondary TRPs.

As the realized TAE is considered as small within a TAEG, the terminal device may estimate the TA also for the secondary TRPs such that the estimation can be considered as precise enough. The estimation may be determined as

$${TA}_{secondary} = {TA}_{primary} + 2 * RTD$$

Thus, the terminal device may determine the required TA values for all N TRPs, which allows also the terminal device to avoid RACH-based procedures that are considered as slow and resource consuming. Thus, as the terminal device obtains the TA value for the primary TRP and based on that, as well as on the measured RTD, the terminal device can determine the TA value for the secondary TRP, the connection to the secondary TRP may be established without preliminary transmission of a random access preamble to the secondary TRP. It is also to be noted that as the terminal device determines the TA value for the secondary TRP, instead of receiving it from the network. The TA value for the secondary TRP may also be understood as an offset with respect to the TA value of the primary TRP, or with respect to another pre-defined value.

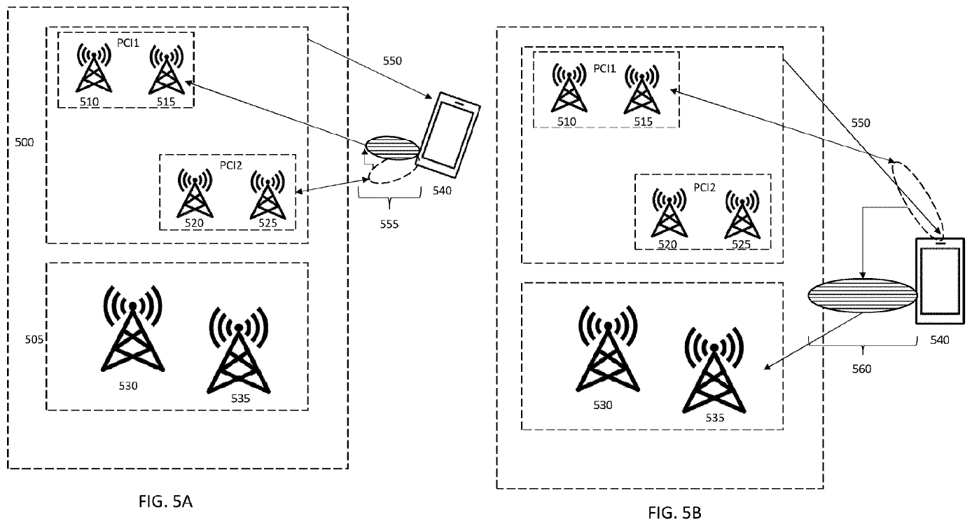

FIG. 5A illustrates another example embodiment, in which there are multiple TRPs and a terminal device 540 is connected to a primary TRP. In this example embodiment there are six TRPs, TRPs 510, 515, 520, 525, 530 and 535. The terminal device 540 is connected to the TRP 515, which in this example embodiment is its primary TRP. Also, for the TRP 515 a TA loop has already been initiated. In this example, the network deployment is such that the network may create two TAEGs, TAEGs 500 and 505. Creating the TAEGs may also be understood as determining the TAEGs. The TAEG 500 comprises the TRPs 510, 515, 520 and 525 and the maximum realized TAE within this group is set to 300 ns in this example embodiment. The TAEG 505 comprises the TRPs 530 and 535, and the maximum realized TAE within this group is set to 300 ns as well in this example embodiment. The terminal device 540 may be informed about the TAEG1 by the TRP 515 transmitting a TAEG configuration 550 to the terminal device 540, and the terminal device 540 may then estimate the RTD between the TRP 515 and for example TRP 525 based on the DL RS. Thus, the terminal device 540 may determine the TA for the TRP 525 as TA 525=TA 515+2*RTD and thereby also avoid RACH procedure for a TC switch or addition 555. Thus, in FIG. 5A, the illustrated example embodiment describes TAEG signalling to group TRPs with small realized TAE to avoid the need for RACH procedure in TCI switch or addition.

In FIG. 5B on the other hand, the example embodiment is like the example embodiment of FIG. 5A, but in this example embodiment the terminal device 540 connects to the TRP 535, which belongs to a TAEG with no TRP in this TAEG for which a TA loop has been initiated, and thus RACH procedure 560 is required in this example embodiment.

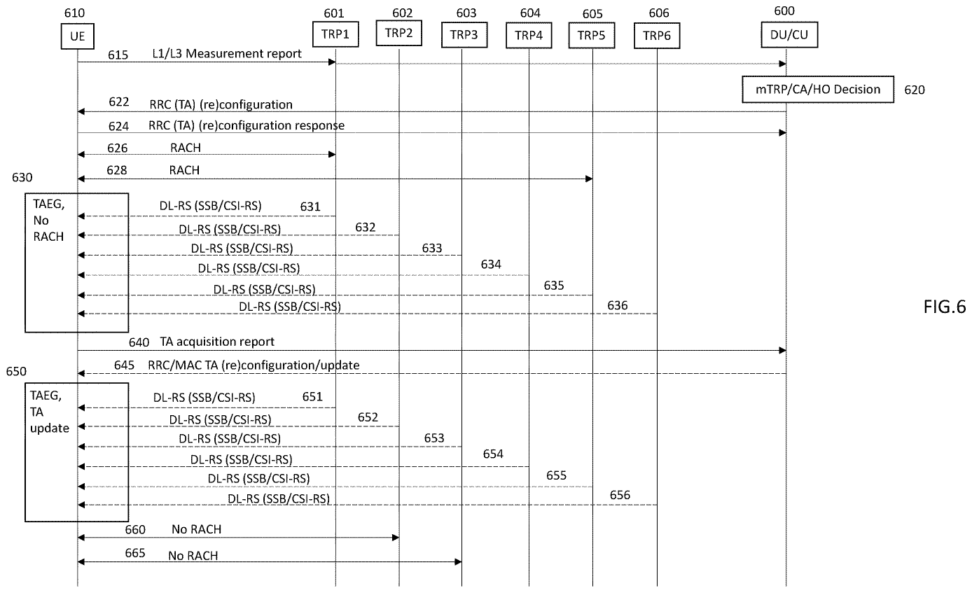

FIG. 6 illustrates a signalling chart according to an example embodiment. In this example embodiment there is a network to which a terminal device 610 is connected. The network has different network entities. In this example embodiment, the network comprises entities such as DU/CU 600 and TRPs 601, 602,603, 604, 605 and 606, at least some which may be comprised in the same access node, or they may be comprised in different access nodes. It is also to be noted that a combination of two or more network entities may also be understood as one network entity in some examples. The signalling illustrated in this signalling chart thus occurs between the terminal device 610 and the network, and the network may be understood to refer to any suitable network entity.

In this example embodiment, the network determines, and thus creates, two TAEGs. The first TAEG comprises the TRPs 601, 602, 603 and 604. The second TAEG comprises the TRPs 605 and 606. In some other example embodiments, there may be more than two TAEGs, and/or the TAEGs may comprise different number of TRPs. In this example embodiment, the terminal device 610 is served by the TRP 601. The terminal device 610 thus measures the other TRPs 602, 603, 604, 605 and 606. As such, it may measure other cells. The terminal device then transmits the measurement report 615 to the network entity 600, which may comprise the DU and/or CU. The network entity 600 then decides 620 to establish intra-cell or inter-cell mTRP, or carrier aggregation, or to prepare for Layer 1 or Layer 2 triggered mobility (LTM) that requires mTRP TA acquisition.

Next, the network entity 600 transmits to the terminal device 610 a response 622 that is radio resource control (RRC) configuration, or reconfiguration. In other words, the terminal device 610 receives from the network entity 600 a configuration with TA acquisition configuration that comprises the TAEG grouping, in other words the grouping of the first and the second TAEGs. As the grouping is indicated to the terminal device 610, the terminal device 610 may initiate transmission towards a TRP other than the primary TRP 601 that is comprised in the first TAEG and that serves the terminal device 610. The initiation may be performed using an initial TA that is based on the TA of another TRP in the group. Further, the TA acquisition configuration may further comprise one or more of the following: indicating the primary and secondary TRPs in a TAEG, time alignment timer (TAT), resource configuration for RACH-based, or SRS based, TA acquisition for primary TRP, resource and measurement configuration, including measurement gap and measurement time, for configuration that are not RACH-based TA acquisitions for secondary cells, and accuracy requirement of the TA acquisition procedure such that in different use cases, such as mTRP or mobility, different level of accuracy may be required. Additionally, the network may configure the terminal device 610 to calculate and apply TA with higher accuracy than the legacy requirement to compensate TAE variations between TRPs of each TAEG. Additionally, the configuration may indicate an identity of the TRP 601, that is the primary TRP, and which is used then to self-determine TA values for the other TRPs. Optionally, the network may also provide the terminal device 610 with information regarding beams of primary and/or secondary TRPs to be used for calculating, or otherwise acquiring RTD and thereby also the TA value. The information regarding the beams may comprise for example TCI-state ID.

The terminal device 610 may then transmit, to the network entity 600 a response 624, that may be an RRC configuration or re-configuration response. The Response 624 indicates the applicability of the proposed TA configuration. The terminal device 610 may also request updates if needed.

Then, the terminal device 610 triggers, or has already triggered, TA acquisition 626 towards the TRP 601 and the TA acquisition 628 towards the TRP 605. The triggered TA acquisitions 626 and 628 are based on RACH, or SRS, transmission.

Then, the terminal device determines, in other words calculates, 630 TA for the TRPs 602, 603, 604, and 606, based on the RTD measurements from the reference signals transmitted by the TRPs, the received TAEG information, and TA knowledge of the TRP 601 and 605, which are the primary TRPs in their respective TAEGs. In this example, embodiment, the downlink reference signals, DL-RS, may be SSB, or CSI-RS. The TRP 601 transmits the DL-RS 631, the TRP 602 transmits the DL-632, the TRP 603 transmits the DL-633, the TRP 604 transmits the DL-634, the TRP 605 transmits the DL-635, and the TRP 606 transmits the DL-636.

Next, the terminal device 610 may transmit to the network entity 600 a TA acquisition report 640 indicating if the TA acquisition was successful or not. Optionally, also the calculated TA values may be transmitted. A successful TA acquisition may be understood for example such that the terminal device 610 was able to perform the process of self-determining the TA for the TRPS 602, 603, 604, and 606, based on the RTD measurements from the reference signals transmitted by the TRPs, the received TAEG information, and TA knowledge of the TRP 601 and 605, which are the primary TRPs in their respective TAEGs. Additionally, or alternatively, the terminal device 610 may later on receive, from the network, and after it has connected to a secondary TRP, a TA adjustment command including a TA offset with respect to the TA value currently used by the terminal deice 610. The absence of such a command, or the inclusion of a small TA value (i.e., below some pre-determined or configured threshold) in the command, may then indicate that the calculated TA value for the secondary TRP is correct, and thus that the TA acquisition with the secondary TRP was successful.

As a response, based on the received TA acquisition report 640, the network entity 600 transmits to the terminal device 610 a further TA configuration for TA reconfiguration or configuration on how the terminal device 610 can update the acquired TA values. Updating may also be understood as tracking. Additionally, the network entity 600 may transmit a TA adjustment command to modify the available TA values at the terminal device 610. Modifying may also be understood as correcting, adjusting or re-acquiring. The network entity 600 may additionally, or alternatively, transmit responsive to a request an update of the TAEG and/or the threshold realized TAE value used as a criteria for determining the group.

Based on the further configuration, the terminal device 610 may perform reacquisition 650 of the TAs. The reacquisition may be based on the DL-RS from the TRPs. The DL-RS may be SSB or CSI-RS. The TRP 601 transmits the DL-RS 651, the TRP 602 transmits the DL-652, the TRP 603 transmits the DL-653, the TRP 604 transmits the DL-654, the TRP 605 transmits the DL-655, and the TRP 606 transmits the DL-656.

The connections 660 and 665 are then established without RACH procedure to the TRP 602 and TRP 603 in this example embodiment. It is to be noted that, in other example embodiment, the connection may also be established to the other secondary TRPs as well. The connection may be triggered by the terminal device 610 or by the network, and the connection may be for communication of for a handover toward other TRPs.

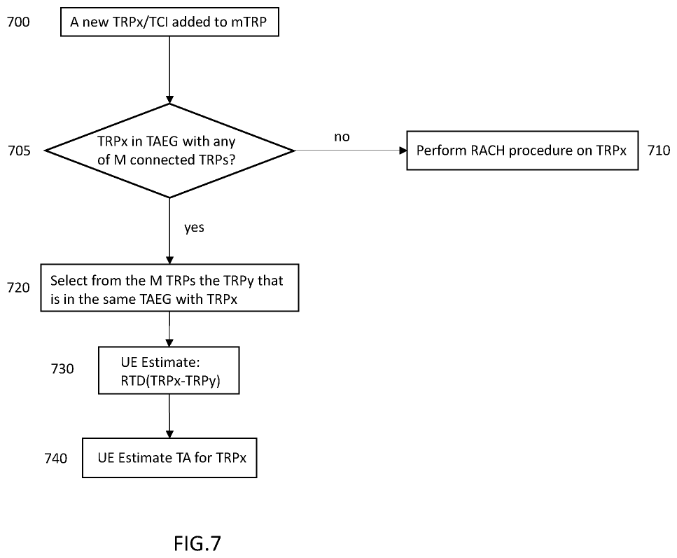

FIG. 7 illustrates a flow chart according to an example embodiment. In this example embodiment, as illustrated in block 700, a terminal device is connected to M TRPs, and the terminal device receives signalling for one or more new TRPx, and its related transmission configuration indication TCI. Based on the signalling, the terminal device is then able to connect to the one or more new TRPx. The signalling may be received individually for each of the one or more new TRPx such that, for each of the one or more new TRPs, their corresponding signalling indicating the TRP and its related TC is received. Additionally, the TAEG of the one or more new TRPx may also be comprised in the received signalling.

Then, in block 705, the terminal device determines if the TRPx that is to be added belongs to a same TAEG that one of a number M of TRPs, to which the terminal device is already connected, and for which the UL synchronization is already in place. If not, the terminal device, in block 710 performs a RACH procedure towards the TRPx that is to be added to acquire the initial TA value. If yes, then the terminal device proceeds to block 720 and selects from the M TRPs the TRPy that is in the same TAEG as the new TRPx for which the connection is to be established. The terminal device is thus configured to add the new TRPx to the mTRPs it is connected to without a RACH procedure for acquiring the initial TA value.

Then, in the block 730, the terminal device estimates RTD between the new TRPx and TRPy, which is in the same TAEG as the TRPx to be added, and in block 740 the terminal device calculates the initial TA value to be used for TRPx.

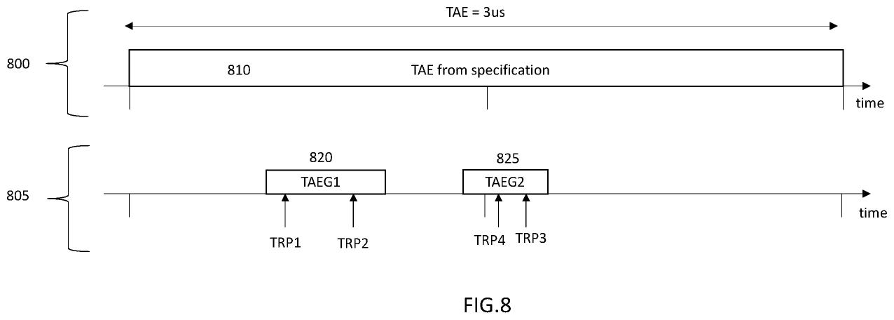

FIG. 8 illustrates TAEs in two different example scenarios 800 and 805. In the example scenario 800, the TAE 810 is a pre-determined TAE according to a specification and, in this example embodiment, is equal to 3 us. The TAE 810 is illustrated along a timeline. As the requirement for the TAE is to be 3 us, the terminal device is to take into account the timing difference between any two TRPs can be up to 3 us.

In the example scenario 805, there are two TAEGs 820 and 825. In the TAEG 820 there are two TRPs comprised, TRP1 and TRP2 and the realized TAE is for instance 500 ns. In the TAEG 825, there are also two TRPs comprised, TRP3 and TRP4. The realized TAE in the TAEG 825 is for instance 300 ns. Thus, in the example scenario 805, the terminal device is informed by the network of the TAEG groups, and the TRPs in the groups are more precisely synchronized than in the example embodiment 800 and the realized TAE is limited.

When informing the TAEGs to the terminal device, the network may use any suitable manner. As an example, the TAEG may be defined in a manner that is similar to TAG configuration as part of cell group configurations. The TAEG configuration may be denoted as TAEG config, for example, and it may have the following exemplary structure:

TAEG-Config ::= SEQUENCE {
taeg-ToReleaseList SEQUENCE (SIZE (1..maxNrofTAEGs)) OF
TAEG-Id,
taeg-ToAddModList SEQUENCE (SIZE (1..maxNrofTAEGs)) OF TAEG
}
TAEG ::= SEQUENCE {
tag-Id TAG-Id,
timeAlignmentAcuuracyRequirement
timeAlignmentAcuuracyRequirementValues
OPTIONAL
}
TAG-Id ::= INTEGER (0..maxNrof TAEGs-1)
timeAlignmentAcuuracyRequirementValues ::= ENUMERATED {nsec10,
nsec50, nsec500}

For example, in intra-cell scenarios, in which TRPs have the same PCI-IDs but different SSB-Indexes, such as TCI state IDs, associations between TAs and TRPs may be defined in various manners. For example, the TA may be associated to a TCI state, or the TA may be associated to CORESETPoolIndex. In one example scenario, an RRC configuration, two TRPs may be implicitly represented with two different control resource set (CORESET) groups, each of which may be identified by the value of RRC parameter CORESETPoolIndex. In this example scenario, a similar approach may also be applied for TAEG association such that TAEG is associated to one or more TCI states or CORESETPoolIndex.

As explained above, the TAEGs may be used for initialization of a TA loop of secondary TRPs. Additionally, the example embodiments described above may further be applicable for the tracking of the TA of the secondary TRPs as well. The tracking may be done as a relative offset of the TA of the secondary TRPs with respect to the TA of the primary TRP. For example, if a single TA loop is used, once a terminal device is transmitting to several TRPs of the same TAEG, it may be beneficial to change at the network side the role of a primary TRP by selecting a different TRP, to which the terminal device is connected, of the same TAEG to be the primary TRP. This allows a primary TRP to be selected to be the one that minimizes the maximum TAE within the group. Additionally, the primary TRP may be selected as to be the one that minimizes the average TAE within the group. Further additionally, the primary TRP may be selected to be the one that minimizes the sum squared TAE value within the group.

The example embodiment described above thus have benefits, such as a terminal device not needing preliminary knowledge of the TAE between a primary TRP and a secondary TRP to derive the exact TA value for the secondary TRP. By grouping the TRPs into TAE groups, for which the maximum incurred TAE remains under a certain threshold, the terminal device is allowed to neglect the TAE while estimating the TA value for a TRP of this TAE group. The estimated TA value may be considered as precise enough for the terminal device to use as an applicable TA value.

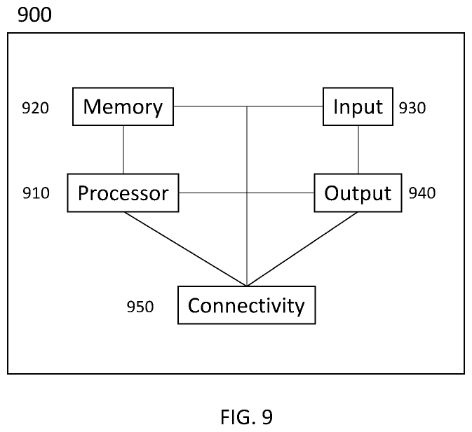

FIG. 9 illustrates an apparatus 900, which may be an apparatus such as, or comprised in, a terminal device, according to an example embodiment. The apparatus 900 comprises a processor 910. The processor 910 interprets computer program instructions and processes data. The processor 910 may comprise one or more programmable processors. The processor 910 may comprise programmable hardware with embedded firmware and may, alternatively or additionally, comprise one or more application specific integrated circuits, ASICs.

The processor 910 is coupled to a memory 920. The processor is configured to read and write data to and from the memory 920. The memory 920 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example RAM, DRAM or SDRAM. Non-volatile memory may be for example ROM, PROM, EEPROM, flash memory, optical storage or magnetic storage. In general, memories may be referred to as non-transitory computer readable media. The memory 920 stores computer readable instructions that are execute by the processor 910. For example, non-volatile memory stores the computer readable instructions and the processor 910 executes the instructions using volatile memory for temporary storage of data and/or instructions.

The computer readable instructions may have been pre-stored to the memory 920 or, alternatively or additionally, they may be received, by the apparatus, via electromagnetic carrier signal and/or may be copied from a physical entity such as computer program product. Execution of the computer readable instructions causes the apparatus 900 to perform functionality described above.

In the context of this document, a “memory” or “computer-readable media” may be any non-transitory media or means that can contain, store, communicate, propagate or transport the instructions for use by or in connection with an instruction execution system, apparatus, or device, such as a computer.

The apparatus 900 further comprises, or is connected to, an input unit 930. The input unit 930 comprises one or more interfaces for receiving a user input. The one or more interfaces may comprise for example one or more motion and/or orientation sensors, one or more cameras, one or more accelerometers, one or more microphones, one or more buttons and one or more touch detection units. Further, the input unit 930 may comprise an interface to which external devices may connect to.

The apparatus 900 also comprises an output unit 940. The output unit comprises or is connected to one or more displays capable of rendering visual content such as a light emitting diode, LED, display, a liquid crystal display, LCD and a liquid crystal on silicon, LCoS, display. The output unit 940 further comprises one or more audio outputs. The one or more audio outputs may be for example loudspeakers or a set of headphones.

The apparatus 900 may further comprise a connectivity unit 950. The connectivity unit 950 enables wired and/or wireless connectivity to external networks. The connectivity unit 950 may comprise one or more antennas and one or more receivers that may be integrated to the apparatus 900 or the apparatus 900 may be connected to. The connectivity unit 950 may comprise an integrated circuit or a set of integrated circuits that provide the wireless communication capability for the apparatus 900. Alternatively, the wireless connectivity may be a hardwired application specific integrated circuit, ASIC.

It is to be noted that the apparatus 900 may further comprise various component not illustrated in the FIG. 9. The various components may be hardware component and/or software components.

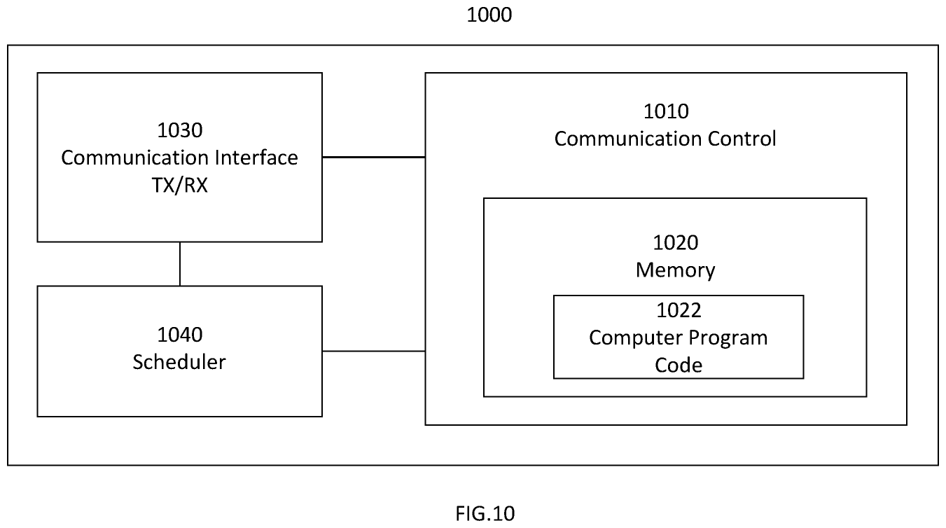

The apparatus 1000 of FIG. 10 illustrates an example embodiment of an apparatus that may be a network entity such as an access node or be comprised in a network entity. The apparatus may be, for example, a circuitry or a chipset applicable to a network entity to realize the described embodiments. The apparatus 1000 may be an electronic device comprising one or more electronic circuitries. The apparatus 1000 may comprise a communication control circuitry 1010 such as at least one processor, and at least one memory 1020 including a computer program code (software) 1022 wherein the at least one memory and the computer program code (software) 1022 are configured, with the at least one processor, to cause the apparatus 1000 to carry out any one of the example embodiments of the access node described above.

The memory 1020 may be implemented using any suitable data storage technology, such as semiconductor-based memory devices, flash memory, magnetic memory devices and systems, optical memory devices and systems, fixed memory and removable memory. The memory may comprise a configuration database for storing configuration data. For example, the configuration database may store current neighbour cell list, and, in some example embodiments, structures of the frames used in the detected neighbour cells.

The apparatus 1000 may further comprise a communication interface 1030 comprising hardware and/or software for realizing communication connectivity according to one or more communication protocols. The communication interface 1030 may provide the apparatus with radio communication capabilities to communicate in the cellular communication system. The communication interface may, for example, provide a radio interface to terminal devices. The apparatus 1000 may further comprise another interface towards a core network such as the network coordinator apparatus and/or to the access nodes of the cellular communication system. The apparatus 1000 may further comprise a scheduler 1040 that is configured to allocate resources.

Even though the invention has been described above with reference to examples according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1-23. (canceled)

24. An apparatus comprising at least one processor, and at least one memory storing instructions that, when executed by the at least one processor, to cause the apparatus at least to:
receive, from a network entity, a configuration indicating a group of transmission and receptions points having a realized timing alignment error upper-bounded by a threshold value;
establish a first connection to a first transmission and reception point comprised in the group;
receive a first timing advance value for uplink transmission to the first transmission and reception point;
determine that a second connection is to be established to a second transmission and reception point;
determine whether the second transmission and reception point is comprised in the group based on the received configuration;
responsive to the second transmission and reception point being comprised in the group:
measure a received time difference between the first transmission and reception point and the second transmission and reception point; and
determine a second timing advance value for uplink transmission to the second transmission and reception point based on the received first timing advance value and the measured received time difference.

25. The apparatus according to claim 24, wherein the second timing advance value is determined as: TA2=TA1+2RTD,
wherein TA1 and TA2 denotes the first and second timing advance values respectively, and RTD denotes the measured received time difference.

26. The apparatus according to claim 24, wherein the received time difference is measured based on reference signals transmitted by the first and second transmission and reception points.

27. The apparatus according to claim 24, wherein the second connection is established without preliminary transmission of a random access preamble to the second transmission and reception point.

28. The apparatus according to claim 24, wherein the configuration further indicates an identity of the first transmission and reception point.

29. The apparatus according to claim 24, wherein the apparatus is further caused to transmit a request for an update of the group and/or of the threshold value.

30. The apparatus according to claim 24, wherein the apparatus is further caused to transmit a report indicating whether the determination of the second timing advance value was successful.

31. The apparatus according to claim 30, wherein the report further indicates the determined second timing advance value.

32. The apparatus according to claim 30, wherein the apparatus is further caused to receive, following the transmission of the report, a command to adjust or re-acquire the second timing advance value.

33. An apparatus comprising at least one processor, and at least one memory storing instructions that, when executed by the at least one processor, to cause the apparatus at least to:
determine a group of transmission and receptions points having a realized timing alignment error upper-bounded by a threshold value; and
transmit, to a terminal device, a configuration indicating the group.

34. The apparatus according to claim 33, wherein:
a first connection is established between the terminal device and a first transmission and reception point comprised in the group, and the first connection is associated with a first timing advance value for uplink transmission to the first transmission and reception point;
a second connection is to be established between the terminal device and a second transmission and reception point comprised in the group, and the second connection is associated with a second timing advance value for uplink transmission to the second transmission and reception point,
and wherein:
the first timing advance value is received by the terminal device;
the second transmission timing advance value is determined by the terminal device based on the received first timing advance value and a received time difference between the first and the second transmission and receptions points measured by the terminal device.

35. The apparatus according to claim 34, wherein the received time difference is measured based on reference signals transmitted by the first and the second transmission and reception points.

36. The apparatus according to claim 34, wherein the second connection is established without the second transmission and reception point preliminary receiving a random access preamble.

37. The apparatus according to claim 34, wherein the apparatus is further caused to receive a report indicating whether the determination of the second timing advance value was successful.

38. The apparatus according to claim 37, wherein the report further indicates the determined timing advance value.

39. The apparatus according to claim 37, wherein the apparatus is further caused to transmit, following the reception of the report, a command to adjust or re-acquire the second timing advance value.

40. The apparatus according to claim 33, wherein the configuration further indicates an identity of the first transmission and reception point.

41. The apparatus according to claim 33, wherein the apparatus is further caused to receive a request for an update of the group and/or of the threshold value.

42. The apparatus according to claim 33, wherein the apparatus is further caused to re-determine the group.

43. A method comprising:
receiving, from a network entity, a configuration indicating a group of transmission and receptions points having a realized timing alignment error upper-bounded by a threshold value;
establishing a first connection to a first transmission and reception point comprised in the group;
receiving a first timing advance value for uplink transmission to the first transmission and reception point;
determining that a second connection is to be established to a second transmission and reception point;
determining whether the second transmission and reception point is comprised in the group based on the received configuration;
responsive to the second transmission and reception point being comprised in the group:
measuring a received time difference between the first transmission and reception point and the second transmission and reception point; and
determining a second timing advance value for uplink transmission to the second transmission and reception point based on the received first timing advance value and the measured received time difference.
